(19) United States
(12) Patent Application Publication
(10) Pub. No.: US 2008/0008792 A1
(43) Pub. Date: Jan. 10, 2008

(54) Microwavable food product packaging and method of making and using the same

(75) Inventors: James C. Mills, Aurora, IL (US); Jeffrey A. Czarny, Schaumburg, IL (US); Daniel C. Reynolds, Montgomery, IL (US)

Correspondence Address: FOLEY & LARDNER LLP, 777 EAST WISCONSIN AVENUE, MILWAUKEE, WI, 53202-5306, US

(73) Assignee: Sara Lee Corporation

(21) Appl. No.: 11/823,117

(22) Filed: Jun. 26, 2007

Related U.S. Application Data
(60) Provisional application No. 60/816,965, filed on Jun. 27, 2006.

(51) Int. Cl. B65D 81/34; H05B 6/80

(52) U.S. Cl. 426/107; 219/725; 219/730; 426/394

(57) ABSTRACT

Microwave packaging for a food product, as well as methods of its making and using, are disclosed. The microwavable food product packaging comprises a bottom wall, at least one side wall, and a floating divider positioned above the bottom wall and within the at least one side wall to at least partially define a bottom region and a top region. The floating divider includes a microwave interactive material and is movable relative to the bottom wall and/or side wall. The may also include one or more vents to allow passage of fluids between the first region and the second region (e.g., oils, fats, and/or other juices from one food product and steam, water vapor, and/or other gases from the other food product). The method for making the packaging comprises providing a bottom wall, at least on side wall; positioning a first food product on microwavable interactive material on the bottom wall; positioning a first floating divider on the first food product and above the bottom wall and within the at least one side wall; and positioning a second food product on the floating divider.

### CROSS-REFERENCE TO RELATED PATENT APPLICATIONS

This application claims priority from U.S. Provisional Patent Application No. 60/816,965, filed on Jun. 27, 2006, which is hereby incorporated herein by reference in its entirety.

### BACKGROUND

The present invention relates to food product packaging and, in particular, to microwavable food product packaging.

Microwave ovens have become a principle form of cooking food in a rapid and convenient manner. Accordingly, the number of food products available for preparation in a microwave oven is constantly increasing. Foods that are specially prepared for cooking within a microwave oven are often delivered to a consumer in packaging or containers that can be used directly within the microwave oven to facilitate preparation. These containers must therefore not only be capable of effectively containing the food product during transport, but must additionally be capable of contributing to the cooking and subsequent presentation of the food.

Consumers are sometimes dissatisfied with food cooked in a microwave since the cooked food lacks many of the characteristics of food prepared in a conventional oven, on a stove top, on a grill, or otherwise. For example, the exterior surfaces of microwaved foods are sometimes soggy and lack the desired degree of crispness and browning. Various attempts have been made to improve the performance characteristics of microwavable packaging with respect to providing the food contained therein with a sufficient degree of crispness and browning. The results of these attempts have been met with limited success, often requiring the consumer to perform multiple steps to place the food or packaging in specific orientations prior to microwave cooking. In addition, some food products may not have been sold in a microwavable form due to difficulties in replicating the product's appearance and flavor when prepared using a more traditional cooking form.

In view of these deficiencies, it would be desirable to provide microwavable food packaging operable to impart desirable characteristics to the food products contained therein during microwave cooking.

### SUMMARY

Embodiments of the present invention relate generally to microwavable food packages, methods of producing microwavable food packages, methods of heating food products in microwave ovens, and related technology.

In one embodiment, a microwavable food package comprises a bottom wall comprising at least one edge, at least one side wall comprising a top edge and a bottom edge wherein the bottom edge is proximate the at least one edge of the bottom wall, and a floating divider comprising a microwave interactive material positioned above the bottom wall and within the at least one side wall. When positioned above the bottom wall and within the at least one side wall, the floating divider at least partially defines a bottom region and top region of the package. In some embodiments, the floating divider is not connected to the bottom wall or a side wall. In other embodiments, the floating divider is connected to a side wall.

In some embodiments of the present invention, a food product can be positioned in the bottom region of the microwavable food package wherein the floating divider comprising a microwave interactive material rests on at least one surface of the food product. The floating nature of the divider can permit the divider to maintain at least partial contact with the food product during shipping, storage, and cooking of the food product in a microwave oven.

In some embodiments, an article, such as a second food product, can be positioned in the top region of the microwavable food package, wherein the article rests on the floating divider further enhancing contact of the floating divider with the food product positioned in the bottom region of the package during shipping, storage, and cooking of the food product in a microwave oven.

In some embodiments, a microwavable food package comprises a receptacle comprising a bottom wall and at least one side wall. A first floating divider comprising a microwave interactive material is positioned within the receptacle, the first floating divider at least partially defining a first region and a second region above the first region. In some embodiments, the microwavable food package further comprises a second floating divider positioned above the first floating divider, the second floating divider at least partially defining a third region above the second region. In some embodiments, the bottom wall comprises a microwave interactive material. In some embodiments, the at least one side wall comprises a microwave interactive material.

In some embodiments of the present invention, a food product can be positioned in the first region of the microwavable food package wherein the first floating divider comprising a microwave interactive material rests on at least one surface of the food product. The floating nature of the first divider can permit the first divider to maintain at least partial contact with the food product during shipping, storage, and cooking of the food product in a microwave oven.

In some embodiments, an article, such as a second food product, can be positioned in the second region of the microwavable food package, wherein the article rests on the first floating divider further enhancing contact of the first floating divider with the food product positioned in the first region of the package during shipping, storage, and cooking of the food product in a microwave oven.

In some embodiments, a second article, such as a third food product, can be positioned in the third region of the microwavable food package, wherein the second article rests on the second floating divider further enhancing contact of the second floating divider with the article positioned in the second region of the package during shipping, storage, and cooking of the food product in a microwave oven.

In another aspect, some embodiments of the present invention provide methods for producing microwavable food packages. A method for producing a microwavable food package, in one embodiment, comprises providing a bottom wall comprising at least one edge, providing at least on side wall comprising a top edge and a bottom edge wherein the bottom edge is proximate the at least one edge of the bottom wall, and positioning a floating divider comprising a microwave interactive material above the bottom wall and within the at least one side wall. When positioned above the bottom wall and within the at least one side wall, the floating divider at least partially defines a bottom and top region of the package. In some embodiments, the bottom wall comprises a microwave interactive material. In some embodiments, the at least one side wall comprises a microwave interactive material.

In other embodiments, a method for producing a microwavable food package comprises providing a receptacle comprising a bottom wall, positioning a food product on the bottom wall, and positioning a floating heating layer above the food product. The floating heating layer can comprises a first surface and a second surface, the first surface comprising a microwave interactive material at least partially in contact with the food product. In some embodiments, a method for producing a microwavable food package further comprises positioning a second food product above the heating layer wherein the second food product is at least partially in contact with the heating layer.

In a further aspect, some embodiments of the present invention provide methods of heating food products in a microwave oven. In one embodiment, a method for heating a food product in a microwave oven comprises disposing at least one food product in contact with a floating microwave interactive material.

In other embodiments, a method for heating a food product in a microwave oven comprises positioning a food product at least partially on a microwave interactive material, positioning a floating heating layer on the food product wherein a first surface of the floating heating layer comprises a microwave interactive material at least partially in contact with the food product, and heating the food product in a microwave oven. In some embodiments, a method for heating a food product in a microwave oven further comprises positioning an article above the heating layer wherein the weight of the article maintains contact between the microwave interactive material on the heating layer and the food product during the heating of the food product.

The present invention relates to a microwave food package. The microwave food package comprises a bottom wall comprising at least one edge; at least one side wall comprising a top edge and a bottom edge, the bottom edge is proximate the at least one edge of the bottom wall; and a floating divider comprising a microwave interactive material positioned above the bottom wall and within the at least one side wall to at least partially define a bottom region and a top region. The floating divider is movable relative to the bottom wall and/or side wall.

The present invention also relates to a microwave food package comprising a container including a bottom wall and at least one side wall coupled to the bottom wall; and a divider comprising a microwave interactive material positioned above the bottom wall and within the at least one side wall. The divider at least partially defines a first region and a second region, the first region containing a first food product and the second region containing a second food product. The divider comprises one or more vents to allow passage of fluids between the first region and the second region (e.g., oils, fats, and/or other juices from one food product and steam, water vapor, and/or other gases from the other food product).

The present invention further relates to microwave packaging for a food product. The packaging comprises a receptacle comprising a bottom wall and at least one side wall; a first floating divider comprising a first microwave interactive material and positioned within the receptacle to at least partially defining a first region containing a first food product and a second region adjacent the first region and containing a second food product; and a second floating divider spaced apart from the first floating divider and at least partially defining a third region, the third region is adjacent the second region and contains a third food product. The first floating divider is movable so that the first microwave interactive material maintains at least partial contact with the first food product during shipping, storage, and/or cooking of the food product in a microwave oven.

The present invention further relates to a method for producing microwavable food packages. The method comprises providing a bottom wall, at least on side wall, and a top wall, the bottom wall having a microwavable interactive material; positioning a first food product on the microwavable interactive material on the bottom wall; positioning a first floating divider on the first food product and above the bottom wall and within the at least one side wall (the first floating divider having a microwave interactive material on at least one major surface of the first floating divider); and positioning a second food product on the floating divider.

The present invention further relates to various features and combinations of features shown and described in the disclosed embodiments. These and other embodiments of the present invention are described in greater detail in the detailed description which follows. Other ways in which the features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### BRIEF DESCRIPTION OF THE DRAWINGS

FIG. 1 illustrates a blank used to form a microwavable food package according to one embodiment of the present invention.

FIG. 2 illustrates a microwavable food package assembled from a single blank according to one embodiment of the present invention.

FIG. 3 illustrates an exploded view of a microwavable food package according to one embodiment of the present invention.

FIGS. 4-9 are views of a sheet or blank of material being formed (e.g., folded) into a packaging according to an exemplary embodiment.

FIG. 10 is a flow diagram of a method of producing a packaged food product for microwave cooking/heating.

FIG. 11 is a flow diagram of a heating food products in a microwave oven using microwave packaging.

FIG. 12 is a perspective view of partially folded microwave packaging with a first food product (e.g., hash browns) inserted into a first or bottom region.

FIG. 13 is a perspective view of partially folded microwave packaging with the first food product covered by a floating divider and a second food product (e.g., sausage patties) inserted onto a second or top region.

### DETAILED DESCRIPTION OF PREFERRED AND EXEMPLARY EMBODIMENTS

Exemplary embodiments relate generally to microwavable food packages, methods of producing microwavable food packages, methods of heating food products in microwave ovens, and related technology.

Microwavable food packaging can provide food products contained therein crispiness and/or browning even as the food product shrinks during cooking in a microwave oven. Microwavable food packages comprise a floating divider operable to maintain contact with at least one surface of a food product contained therein during cooking in a microwave oven. Floating dividers comprise microwave interactive materials operable to provide browning and/or crisping to food products in contact with the floating divider.

In one embodiment, a microwavable food package comprises a bottom wall comprising at least one edge, at least one side wall comprising a top edge and a bottom edge wherein the bottom edge is proximate the at least one edge of the bottom wall, and a floating divider comprising a microwave interactive material positioned above the bottom wall and within the at least one side wall. The floating divider at least partially defines a bottom region and top region of the package in this embodiment.

Turning now to components that can be included in some of the exemplary embodiments, microwavable food packages can comprise a bottom wall comprising at least one edge. In some embodiments, the bottom wall can comprise a plurality of edges. In some embodiments, a bottom wall comprises four edges.

In exemplary embodiments, the bottom wall comprises an interior surface and an exterior surface and can have any desired shape, such as triangular, square, rectangular, circular, oval, polygonal, etc. In some embodiments, the interior surface of the bottom wall can comprise a microwave interactive material.

A microwave interactive material, as used herein, is a material operable to convert microwave electromagnetic energy into heat energy. A microwave interactive material can be an electroconductive or semiconductive material, such as metal foil, vacuum deposited metal, or metallic ink. In some embodiments, an electroconductive material can comprise metals such as aluminum, copper, iron, nickel, other transition metals, and/or alloys thereof. Semiconductive materials, according to some embodiments, can comprise zinc oxide, germanium oxide, and barium titanate. In some embodiments, a microwave interactive material can comprise a non-conductive artificial dielectric or ferroelectric. Artificial dielectrics comprise conductive subdivided material in a polymeric or other suitable matrix or binder and can include flakes of electroconductive material such as aluminum. A microwave interactive material, in some embodiments, can comprise a patterned susceptor comprising one or more layers of suscepting material.

Microwave interactive materials can be obtained from various commercial sources known to one of skill in the art. Moreover, one of skill in the art would recognize microwave interactive materials suitable for any desired application.

In some embodiments, the interior surface of a bottom wall can comprise a patterned microwave interactive material. A patterned microwave interactive material, in some embodiments, can be operable to provide localized areas of heating and shielding in the microwavable package. Areas of the bottom wall comprising a microwave interactive material, for example, can absorb incident microwave energy and subsequently convert the microwave energy into heat energy. The heat energy generated can be used to brown and/or crisp the surface of a food product in contact or close proximity to the microwave interactive material. Depending on the food product, the heat generated from the microwave interactive material may or may not contribute significantly to heating the interior of the food product.

Areas of the bottom wall not comprising a microwave interactive material, as a result of patterning, will not absorb incident microwave energy thereby allowing the incident microwave energy to pass to the food product. Incident microwave energy passing directly to the food product can be used to heat the interior regions of the food product. As a result, patterning of a microwave interactive material on the interior surface of the bottom wall can permit channeling and shielding of incident microwave energy in any desired fashion.

In addition to a bottom wall, a microwavable food package in some embodiments can comprise at least one side wall. In some embodiments, a microwavable food package comprises a plurality of side walls. In one embodiment, a microwavable food package comprises a number of side walls commensurate with the shape of the bottom wall. A microwavable food package, for example, can comprise four side walls when the bottom wall is a quadrilateral.

Side walls, according to some embodiments, comprise a top edge and a bottom edge as well as interior and exterior surfaces. The bottom edge of a side wall can be proximate to at least one edge of a bottom wall in some embodiments. In some embodiments, the interior surface of a side wall can comprise a microwave interactive material. In some embodiments, the interior surface of a side wall can comprise a patterned microwave interactive material as described above.

A microwavable food package can also comprise a floating divider comprising a microwave interactive material. The floating divider is positioned above the bottom wall and within the at least one side wall of the package. The floating divider comprises a first surface and a second surface wherein the first surface faces the bottom wall. In some embodiments, the first surface of the floating divider can comprise a microwave interactive material. In one embodiment, the first surface of the floating divider can comprise a patterned microwave interactive material as described above. In some embodiments, the second surface can comprise a microwave interactive material, including a patterned microwave interactive material.

When positioned above the bottom wall and within the at least one side wall, the floating divider at least partially defines a bottom region and a top region of the microwavable food package. In some embodiments, a first food product can be positioned in the bottom region of the container. The floating divider rests on the first food product. The floating nature of the divider allows the divider to maintain contact with the first food product during shipping, storing, and cooking of the food product in a microwave oven. If the first food product shrinks during cooking in a microwave oven, the floating divider can maintain at least partial contact with one or more surfaces of the first food product. In some embodiments, the floating divider further comprises one or more vents to pass steam and other gases evolved from the first food product during microwave cooking.

In embodiments wherein the first surface of the floating divider comprises a microwave interactive material, the first surface maintains at least partial contact with at least one surface of the food product during microwave cooking thereby providing enhanced browning and/or crisping of the food product surface. The floating nature of the divider permits the first surface comprising the microwave interactive material to maintain contact with one or more surfaces of the first food product even as the first food product shrinks during microwave cooking.

In some embodiments, an article, such as a second food product, can be positioned in the top region of the microwavable food package at least partially defined by the floating divider. In embodiments wherein an article is positioned in the top region, the article rests on the floating divider. In such embodiments, the article acts as a weight further enhancing contact of the floating divider with the first food product. As a result, an article positioned in the top region of the package can assist the floating divider in maintaining contact with at least one surface of the first food product as the first food product shrinks during microwave cooking further enhancing browning and/or crisping of the first food product.

Additionally, in embodiments wherein the floating divider comprises vents, oils and fats and other juices evolved from the microwave cooking of the second food product (in embodiments where the second food product generates oils, fats, and/or juices) positioned in the top region of the package can flow through the vents to surfaces of the first food product further enhancing browning and/or crisping of the first food product by the microwave interactive material on the first surface of the floating divider. Moreover, steam, water vapor, and other gases evolved from the cooking of the first food product can pass through the vents providing moisture to the second food product. In some embodiments, the moisture provided by the steam and water vapor can retard or prevent the second food product from drying out during cooking in a microwave oven.

In some embodiments, the floating divider is not attached to the bottom wall or any side wall of the microwavable food package and is supported by the first food product. In other embodiments, the floating divider can be attached to a side wall of the microwavable food package. In such embodiments, the floating divider can be hingedly attached to a side wall allowing free movement of the divider.

In some embodiments, the floating divider can further comprise a tab. The tab on the floating divider can permit a consumer to easily remove the floating divider from the package to provide access the to the first food product underneath. In embodiments wherein a second food product is positioned on the floating divider, the tab can assist a consumer in removing the second food product from the package. In some embodiments, the tab on a floating divider does not comprise a microwave interactive material.

A number of different foods can comprise a first food product which is positioned between a bottom wall and a floating divider in some embodiments. As described below, any number of food products can be placed in the package. In embodiments where a microwave interactive material is provided on the bottom wall and on a surface of the floating divider, food products where browning is desirable on multiple surfaces can be provided in some embodiments.

In some embodiments, a first food product can comprise a vegetable. Non-limiting examples of vegetables that can be provided in some embodiments include, without limitation, Brussels sprouts, cauliflower, soy, cabbage, legumes, beans, peas, fried okra, asparagus, garlic, onion, shallots, carrots, daikons, radishes, potatoes, sweet potatoes, turnips, vegetable based protein products, and other vegetables. Potatoes represent one example of a food product where browning and crispness on multiple surfaces might be desired. For example, it might be desirable to prepare French fries, hash browns, home fries, tater tots, or other potato-based foods in the microwave. Such foods are often browned on multiple surfaces. Thus, some embodiments might be useful in cooking potatoes and potato-based foods. Prior to packaging and/or cooking, the potatoes or other food products might be cut, sliced, chopped, diced, shredded, or otherwise prepared in some embodiments.

In some embodiments, a first food product can comprise rice (brown, polished, etc.), nuts (peanuts, pecans, almonds, cashews, tree nuts, etc.).

In some embodiments, a first food product can comprise a meat. Non-limiting examples of meats that can be provided in some embodiments include, without limitation, beef, sausage, pork, poultry (e.g., turkey, chicken, ostrich, etc.), buffalo, fish and other seafood, and any other animal product. In some embodiments, a meat can comprise a meat source, seasonings, flavorings, fillers, preservatives, sauces, water and/or other ingredients known to those of skill in the art.

In another embodiment, a first food product can comprise a seafood, including fish, shellfish, and crustaceans. In some embodiments, a first food product can comprise eggs, egg derivates, such as egg whites and egg yokes, and egg substitutes.

In some embodiments, a first food product can comprise bread or pasta. Examples of bread that can be provided in some embodiments include, without limitation, sandwich bread, rolls, flat bread, pita bread, hoagie rolls, and other bread products. Some embodiments might be useful in browning the top and bottom surfaces of bread for use in preparing a grilled sandwich product.

The first food product, in some embodiments, can comprise various combinations of the above foods.

In embodiments where a second food product is provided and positioned above the floating divider, the second food product can provide any of the foods discussed above as well as others. For example, in various embodiments, a second food product can comprise one or more vegetables, one or more meats, one or more breads, one or more pastas, sauces, etc.

Food products, including first and second food products, which can be positioned in microwavable food packaging of the present invention, in some embodiments, comprise frozen and/or refrigerated food products.

In some embodiments, a second food product may not be desired. In such embodiments where weight is still needed to maintain contact between the floating divider and the first food product as it cooks, an article comprising a non-food product can be provided above the floating divider in some embodiments. Non-limiting examples of non-food products can include polypropylene, crystallized polyethylene terephthalate (CPET), and other microwave-safe materials.

In some embodiments, an article comprising a secondary container can be provided above the floating divider to maintain contact between the floating divider and first food product as it cooks. In one embodiment, a secondary container can comprise a bowl or other receptacle in which to place the first food product after cooking the first food product in a microwave oven. The first food product could be subsequently consumed from the bowl. In some embodiments, the secondary container can further comprise a second food product. The first food product, in some embodiments, can be mixed with the second food product in the secondary container subsequent to cooking in a microwave oven. Embodiments contemplate that any number of food products of a microwavable package can be combined in a secondary container positioned within the microwavable package as provided herein. A secondary container, in some embodiments, can be constructed of polypropylene, ultrahigh molecular weight polyethylene (UHMWPE), high density polyethylene (HDPE), crystallized polyethylene terephthalate (CPET), paperboard, and other microwave-safe materials.

In some embodiments, an article comprising on or more utensils for assisting in consuming the first food can be provided above the floating divider. Utensils, in some embodiments, can be constructed of polypropylene, crystallized polyethylene terephthalate (CPET), and other microwave-safe materials.

Microwavable packages of the present invention contemplate various combinations of first and second food product types. A number of factors can be considered in determining which foods to include in such a package including, without limitation, whether the food products are often prepared together, whether the food products are to provide a particular meal (e.g., breakfast, lunch, dinner) to a consumer, whether the food product can be prepared in the microwave and maintain a desirable flavor, texture, and moisture level, the cost of the food product, whether the product freezes well, the popularity of the food product among consumers, whether the food product generates fats, oils, or juices during cooking, how well the product browns when cooked in a microwave, and other factors.

In one embodiment, for example, the first food product comprises a potato, such as a shredded potato, and the second food product comprises one or more pieces of sausage. During microwave cooking, the bottom wall and the first surface of the floating divider, each comprising a microwave interactive material, contacts the shredded potatoes resulting in browning and/or crisping of the shredded potatoes. As the shredded potatoes shrink during microwave cooking, the floating divider maintains contact with the shredded potatoes providing enhanced crisping and/or browning of the shredded potatoes, due in part to the weight of the sausages.

The sausage placed on the second surface of the floating divider provides weight which assists the floating divider in maintaining contact with the shredded potatoes during microwave cooking. In embodiments where the floating divider comprises vents, oils and juices evolving from the sausage during microwave cooking can flow through the vents and to the shredded potatoes further enhancing the crisping and/or browning of the shredded potatoes. In some embodiments, the second surface of the floating divider may have a surface area which is smaller than the opening provided by the side wall of the package. In such embodiments, oils and juices from the sausages may flow to the product below the floating divider through gaps between the floating divider and the side wall. Moreover, steam and other gases evolved from the potatoes during microwave cooking, in some embodiments, can pass through the vents in the floating divider and gaps between the floating divider and the side walls to provide the sausage with moisture. Providing the sausage with moisture, in some embodiments, can retard or prevent the sausage from drying out during cooking in a microwave oven.

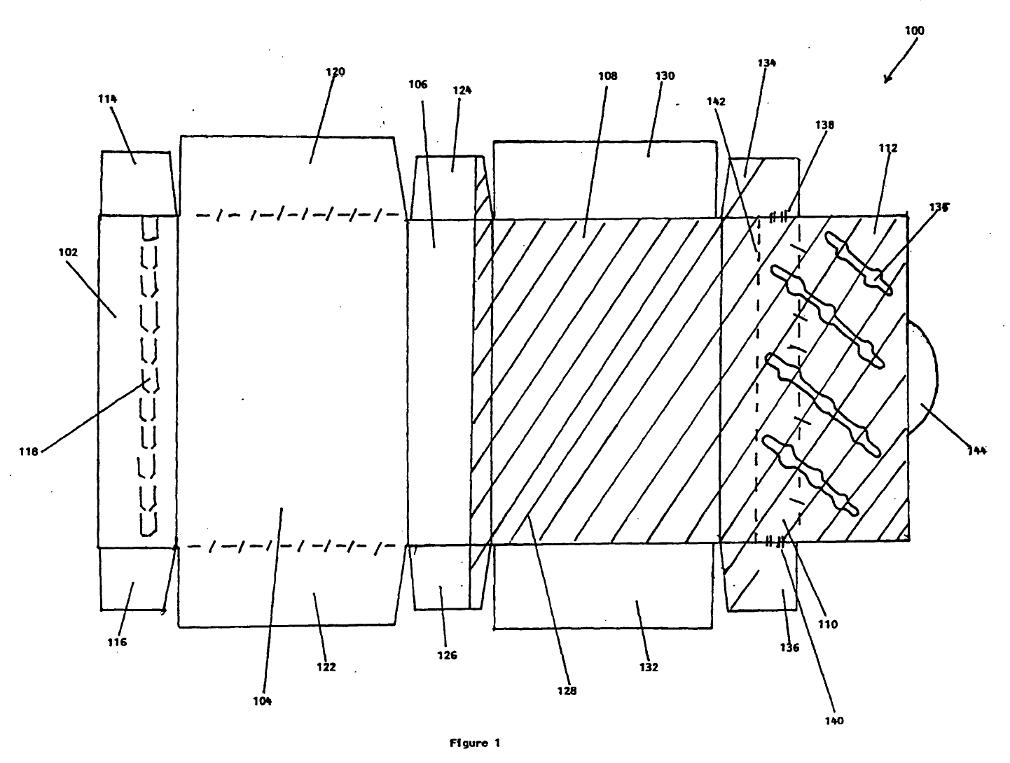

In some embodiments, a microwavable food package of the present invention can be formed from a single blank, such as a cardboard or paperboard blank. FIG. 1 illustrates a blank operable to be assembled into a microwavable food package according to an embodiment of the present invention. The blank (100) comprises an outer front panel (102), a top panel (104), a back panel (106), a bottom panel (108), an inner front panel (110), and a floating divider (112). The outer front panel (102) comprises two glue flaps (114, 116) and a zip strip (118) operable to assist in opening the microwavable food package. The top panel (104) comprises two cover end panels (120, 122), and the back panel (106) comprises two minor panels (124, 126). The cover end panels (120, 122) are scored to facilitate opening of the microwavable package. The back panel (106) and two associated minor back panels (124, 126) comprise a microwave interactive material (128). The bottom panel (108) comprises two inner major end panels (130, 132). The bottom panel additionally comprises a microwave interactive material (128). The inner front panel (110) and two associated minor front panels (134, 136) also comprise a microwave interactive material (128). The floating divider (112) comprises a microwave interactive material (128) and a plurality of vents (135). The floating divider additionally comprises a tab (144).

The blank (100) illustrated in FIG. 1 can be assembled into a microwavable food package of the present invention by manual or automated means. An adhesive material, such as glue, is applied to each of the interior surfaces of the inner major end panels(120, 122). The minor front panels (134, 136) and minor back panels (124, 126) are subsequently folded and adhered to the inner major panels (120, 122) forming an interior region defined by the back panel (106), bottom panel (108), and inner front panel (110). The minor front panels (134, 136) and minor back panels (124, 126) can be adhered to the inner major panels (120, 122) by any adhesive, such as glue, known to one of skill in the art.

Nick ties (138, 140) are disposed between the inner front panel (110) and two associated minor front panels (134, 136) and a score line (142) is provided through the inner front panel (110). Subsequent to adhering the minor front panels (134, 136) and minor back panels (124, 126) to the inner major panels (120, 122), the nick ties (138, 140) are cut and the front inner panel (110) is folded outward along the score line or perforation (142). The top panel (104) and outer front panel (102) are additionally folded outward from the interior region of the microwavable package.

A first food product can be positioned in the interior region defined by the back panel (106), bottom panel (108), and inner front panel (110). Subsequent to positioning of the first food product, the floating divider (112) and a portion of the inner front panel (110) can be folded inwardly along the score line (142) to position the floating divider (112) above the bottom panel (108) and in contact with the first food product. When the microwavable package is machine assembled, a kick arm can be used to inwardly rotate the floating divider (112) and a portion of the inner front panel (110) about the score line (142) and into position above the bottom panel (108).

In some embodiments, a score line is present between the inner front panel (110) and floating divider (112). The score line allows the floating divider (112) to separate from the inner front panel subsequent to positioning above the bottom panel (108) and first food product.

A second food product can be placed on the floating divider (112) after positioning of the floating divider (112) above the bottom panel (108) and first food product. The top panel (104) can be folded over the second food product and secured to the inner front panel (110). The outer front panel (102) can be secured to the inner front panel (110) through an adhesive such as glue. The two glue flaps (114, 116) associated with the outer front panel (102) can be adhesively secured to the two inner major end panels (130, 132), and the cover end panels (120, 122) associated with the top panel (104) can be adhesively secured to the two glue flaps (114, 116) to complete the microwavable food package.

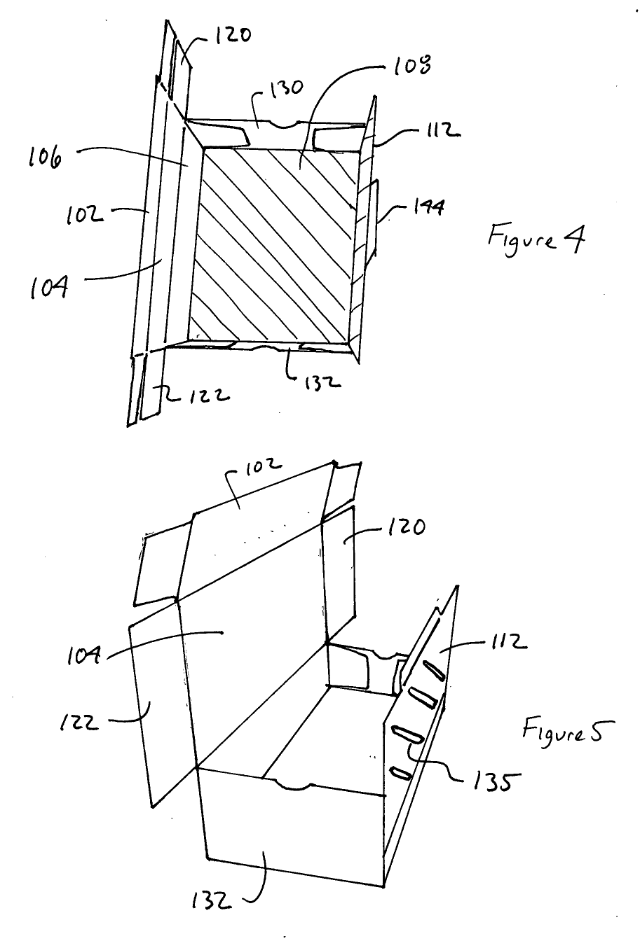

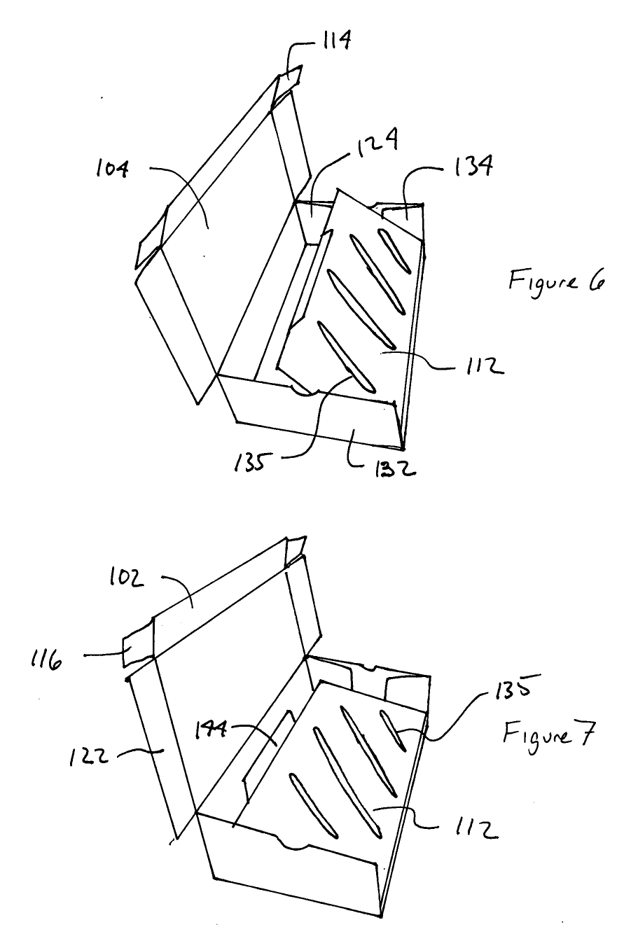

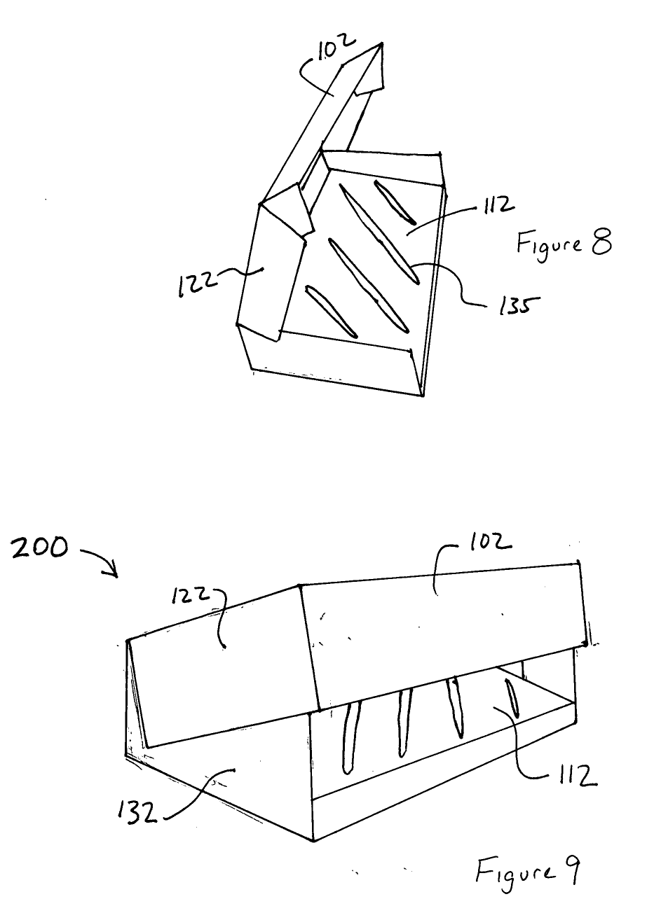

FIGS. 4-9 illustrate formation of a microwavable food package from a single paperboard blank consistent with that illustrated in FIG. 1 and described above. It should be noted that the blank shown in the FIG. 4 shows microwave interactive materials on the blank as diagonal lines and represent locations where microwave interactive material could be placed. Similarly, the vents (e.g., openings, apertures, slits, cuts, etc.) represent locations where vents can be cut in some embodiments of food packages as described above. FIGS. 4-9 also show potential locations of perforations, zip strips, and score lines.

The microwavable food package assembled from the single blank can be opened by removing the zip strip (118) of the outer front panel (102). In some embodiments, zip strip (118) can be removed from left to right. In other embodiments, the zip strip (118) can be removed from right to left. Subsequent to removing the zip strip (118), the outer front panel (102) and top panel (104) can be folded back along the scores in the cover end panels (102, 122) to provide access to the second food product positioned in the top region of the package. A portion of the top outer panel (102) can remain adhered to the inner front panel (110) subsequent to removing the zip strip (118) After opening, the microwavable package can be placed in a microwave over for cooking of the food products disposed therein. No additional steps, such as orienting the package or food product, is necessary prior to cooking the food product.

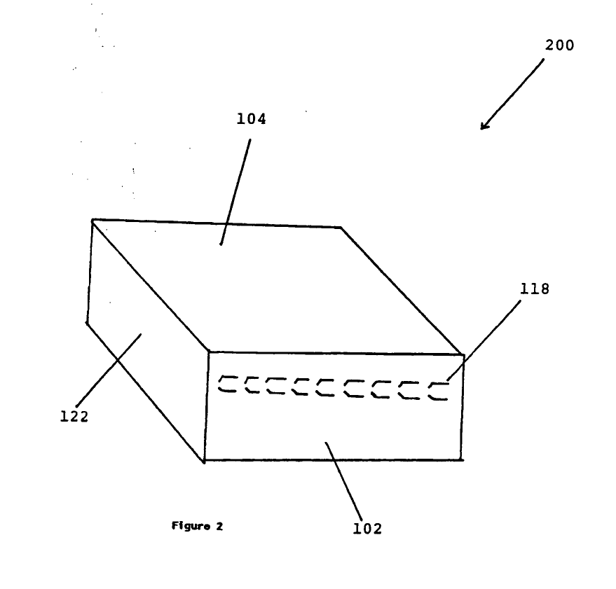

FIG. 2 illustrates a microwavable food package assembled from a single blank consistent with that provided in FIG. 1 according to an embodiment of the present invention. The view provided in FIG. 2 displays the outer front panel (102), zip strip (118), top panel (104), and one cover end panel (122) of the assembled microwave package (200).

In another embodiment, a microwavable food package comprises a receptacle comprising a bottom wall and at least one side wall. A first floating divider comprising a microwave interactive material is positioned in the receptacle above the bottom wall. When positioned in the receptacle, the first floating divider at least partially defines a first region and a second region above the first region.

In exemplary embodiments, the bottom wall of the receptacle comprises an interior surface and an exterior surface and can have any desired shape such as triangular, square, rectangular, circular, oval, polygonal, etc. In some embodiments, the interior surface of the bottom wall comprises a microwave interactive material. In one embodiment, the interior surface of the bottom wall comprises a patterned microwave interactive material.

In addition to the bottom wall, the receptacle comprises at least one side wall. In some embodiments, the receptacle comprises a plurality of side walls. Side walls of the receptacle, in some exemplary embodiments, comprise an interior surface and an exterior surface. In some embodiments, the interior surface of a side wall can comprise a microwave interactive material. In one embodiment, the interior surface of a side wall comprises a patterned microwave interactive material.

The microwavable food package also comprises a first floating divider comprising a microwave interactive material positioned in the receptacle above the bottom wall. The first floating divider comprises a first surface and a second surface wherein the first surface faces the bottom wall of the receptacle. In some embodiments, the first surface of the first floating divider comprises a microwave interactive material. In one embodiment, the first surface of the first floating divider comprises a patterned microwave interactive material.

When positioned in the receptacle above the bottom wall, the first floating divider at least partially defines a first region and a second region above the first region. In exemplary embodiments, a first food product can be positioned in the first region of the microwavable package. The first floating divider rests on the first food product. The floating nature of the first divider allows the first divider to maintain contact with the first food product during shipping, storage, and cooking of the first food product in a microwave oven. When the first food product shrinks during cooking in a microwave oven, the first floating divider maintains at least partial contact with one or more surfaces of the first food product. In some embodiments, the first floating divider further comprises one or more vents operable to pass steam and other gases evolved from the first food product during microwave cooking.

In embodiments wherein the first surface of the first floating divider comprises a microwave interactive material, the first surface maintains at least partial contact with one or more surfaces of the first food product during microwave cooking thereby providing enhanced browning and/or crisping of the first food product surface. The floating nature of the divider permits the first surface comprising the microwave interactive material to maintain contact with one or more surfaces of the first food product even as the first food product shrinks during microwave cooking.

In some embodiments, an article, such as a second food product, can be positioned in the second region of the microwavable food package at least partially defined by the first floating divider. In embodiments wherein an article is positioned in the second region, the article rests on the first floating divider. In such embodiments, the article acts as a weight further enhancing contact of the first floating divider with the first food product. As a result, an article positioned in the second region of the package can assist the first floating divider in maintaining contact with at least one surface of the first food product as the first food product shrinks during microwave cooking, further enhancing browning and/or crisping of the first food product.

In some embodiments, the microwave food package can further comprise a second floating divider positioned in the receptacle above the first floating divider. The second floating divider comprises a first surface and a second surface wherein the first surface faces the bottom wall of the receptacle. In some embodiments, the first surface of the second floating divider comprises a microwave interactive material. In one embodiment, the first surface of the second floating divider comprises a patterned microwave interactive material.

When positioned in the receptacle above the first floating divider, the second floating divider at least partially defines a third region above the second region. In some embodiments, the second floating divider rests on the article placed on the first floating divider. In some embodiments, the article comprises a second food product as described above. The floating nature of the second divider allows the second divider to maintain contact with the second food product during shipping, storage, and cooking of the second food product in a microwave oven. When the second food product shrinks during cooking in a microwave oven, the second floating divider maintains at least partial contact with one or more surfaces of the second food product. In some embodiments, the second floating divider further comprises one or more vents operable to pass steam and other gases evolved from the first food product during microwave cooking.

In embodiments wherein the first surface of the second floating divider comprises a microwave interactive material, the first surface maintains at least partial contact with one or more surfaces of the second food product during microwave cooking thereby providing enhanced browning and/or crisping of the second food product surface. The floating nature of the second divider permits the first surface comprising the microwave interactive material to maintain contact with one or more surfaces of the second food product even as the second food product shrinks during microwave cooking.

In some embodiments, an article, such as a third food product, can be positioned in the third region of the microwavable food package at least partially defined by the second floating divider. In embodiments wherein an article is positioned in the third region, the article rests on the second floating divider. In such embodiments, the article acts as a weight further enhancing contact of the second floating divider with the second food product. As a result, an article positioned in the third region of the package can assist the second floating divider in maintaining contact with at least one surface of the second food product as the second food product shrinks during microwave cooking, further enhancing browning and/or crisping of the second food product.

Exemplary embodiments contemplate the use of a plurality of floating dividers comprising microwave interactive materials, including greater than two floating dividers. Additional floating dividers can be positioned in microwavable packaging as provided herein to at least partially define any desired number of compartments.

In some embodiments, microwavable food packages of the present invention further comprise a cover or lid. The cover, according to some embodiments, can be coupled to the at least one side wall. In one embodiment, the cover can be hingedly attached to the side wall. In other embodiments, the cover can slide over the receptacle to effectuate closure of the package.

The cover of a microwavable package, according to some exemplary embodiments, can be used as a stand for the receptacle. In one embodiment, the cover can fold back and under the receptacle to form the stand. In another embodiment, the cover can slide off the receptacle, and the receptacle can be subsequently stacked on the cover. The ability of the cover to serve as a stands permits the receptacle to be lifted off the microwave floor, which can lead to enhanced microwave cooking.

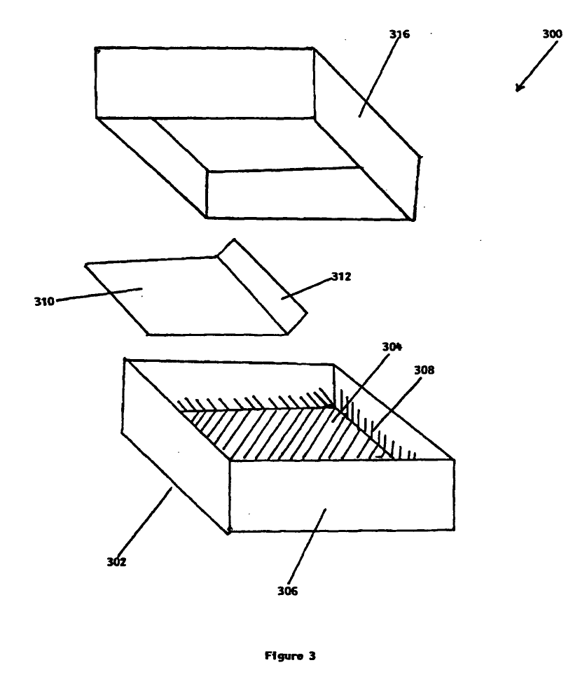

FIG. 3 is an exploded view of a microwavable food package according to an embodiment of the present invention. The microwavable food package (300) comprises a bottom tray (302) comprising a bottom wall (304) and a plurality of side walls (306). The interior surfaces of the bottom wall (304) and side walls (306) comprise a microwave interactive material (308).

The microwavable food package (300) also comprises a floating divider (310). The floating divider (310) comprises a microwave interactive material (308) located on the underside of the floating divider (310). The floating divider (310) additionally comprises a tab (312). The tab (312) can permit a consumer to easily remove the floating divider (310) from the microwavable food package (300) to provide access to a food product contained therein. In embodiments wherein a food product is placed on the floating divider (310), the tab (312) can assist a consumer in removing the food product form the microwavable package (300). As shown in FIG. 3, the floating divider (310) is not coupled to any side wall (306) of the tray (302) and can rest on a food product (314) positioned in the tray (302). In other embodiments (not shown), the floating divider (310) can be coupled to a side wall (306) of the tray (302). The microwave interactive material (308) of the floating divider (310) contacts with the food product on which the floating divider (310) rests.

The floating nature of the divider (310) enables the divider (310) to maintain contact with one or more surfaces of the food product during shipping, storage, and cooking of the food product in the microwavable food package (300). When the food product shrinks during cooking in a microwave oven, the floating divider (310) maintains at least partial contact with one or more surfaces of the food product thereby providing enhanced browning and/or crisping of the food product.

The microwavable food package (300) further comprises a cover. The cover comprises a top tray (316) operable to slide over the bottom tray (302). The top tray (316), in some embodiments, can additionally serve as a stand for the bottom tray (302) during cooking in a microwave oven. In such embodiments, the top tray (316) can be inverted and the bottom tray (302) placed on the top tray (316). In some embodiments, the top tray (302) can comprise one or more notches (not shown) in the side walls of the tray which can facilitate a consumer removing the top tray (306) from the bottom tray (302). Moreover, when the top tray (316) is used as a stand for the bottom tray during cooking in a microwave oven, the notched in the side walls of the top tray (316) can allow air flow and circulation through the top tray (316) which can further enhance microwave cooking of one or more food products in the microwavable package. In a further embodiment, the top tray (316) can comprise additional vents in the side walls to further promote air circulation during microwave cooking.

In some embodiments, the top tray (316) can be used as a container for at least one food product cooked in the microwavable package (300). In one embodiment, for example, a second food product positioned on the floating divider (310) can be removed from the bottom tray (302) and placed in the top tray (316) subsequent to cooking in a microwave oven. A consumer can use the tab (312) on the floating divider (310) to assist in removing the floating divider (310) and second food product positioned thereon from the bottom tray (302).

In some embodiments, microwavable packaging of the present invention can be positioned within another package for shipping or retail sale. In one embodiment, one or microwavable packages comprising at least one food product can be stacked in larger containers such as boxes for shipping to a retail environment. In another embodiment, a plurality of microwavable packages, each comprising at least one food product can be placed within larger packaging, such as a carton, for retail sale together. Two microwavable packages, for example, can be disposed in a carton for sale together.

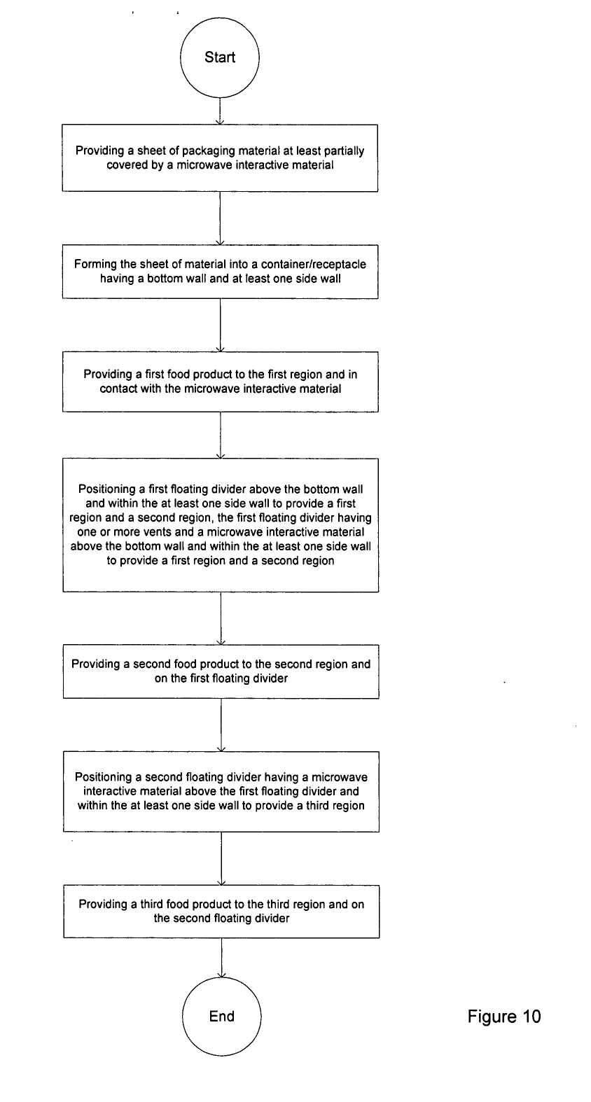

In another aspect, the present invention provides methods for producing microwavable food packages. FIG. 10 is a flow diagram of an exemplary method of producing a packaged food product for microwave cooking/heating. The method 400 comprises providing a sheet of packaging material at least partially covered by a microwave interactive material (step 402); forming the sheet of material into a container/receptacle having a bottom wall and at least one side wall (step 404); providing a first food product to the first region and in contact with the microwave interactive material (step 406); positioning a first floating divider above the bottom wall and within the at least one side wall to provide a first region and a second region, the first floating divider having one or more vents and a microwave interactive material above the bottom wall and within the at least one side wall to provide a first region and a second region(step 408); providing a second food product to the second region and on the first floating divider (step 410); positioning a second floating divider having a microwave interactive material above the first floating divider and within the at least one side wall to provide a third region (step 412); providing a third food product to the third region and on the second floating divider(step 414).

A method for producing a microwavable food package, in one embodiment, comprises providing a bottom wall comprising at least one edge, providing at least on side wall comprising a top edge and a bottom edge wherein the bottom edge is proximate the at least one edge of the bottom wall, and positioning a floating divider comprising a microwave interactive material above the bottom wall and within the at least one side wall. When positioned above the bottom wall and within the at least one side wall, the divider at least partially defines a bottom and top region of the package. In some embodiments, the bottom wall comprises a microwave interactive material. In some embodiments, the at least one side wall comprises a microwave interactive material.

In another embodiment, a method for producing a microwavable food package comprises providing a receptacle comprising a bottom wall, positioning a food product on the bottom wall, and positioning a floating heating layer above the food product. The heating layer comprises a first surface and a second surface, the first surface comprising a microwave interactive material at least partially in contact with the food product. In some embodiments, a method for producing a microwavable food package further comprises positioning a second food product above the heating layer wherein the second food product is at least partially in contact with the heating layer.

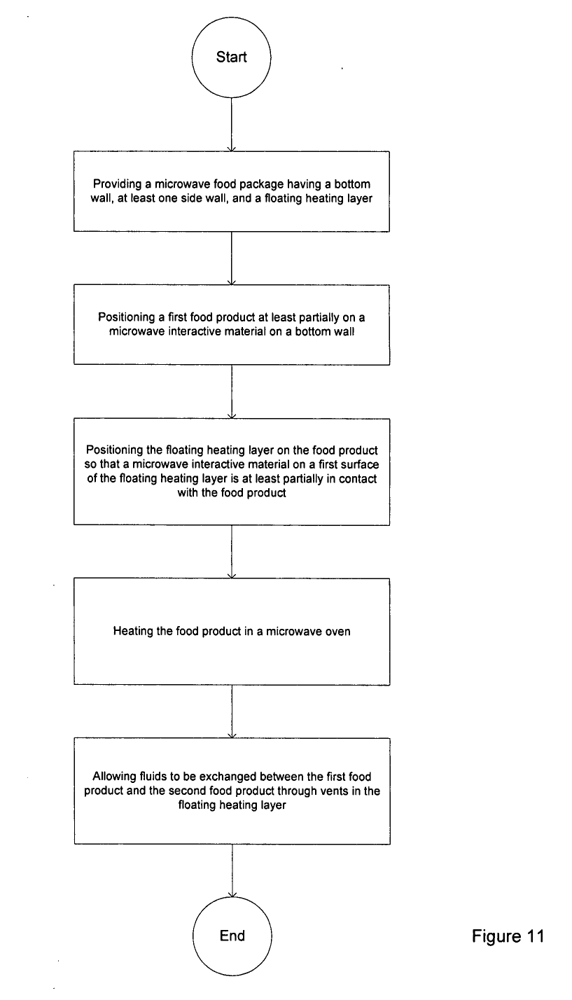

The various embodiments of packaging provide methods of heating food products in a microwave oven. FIG. 11 is a flow diagram of a method (500) for heating food products in a microwave oven using microwave packaging. The method 500 comprises providing a microwave food package having a bottom wall, at least one side wall, and a floating heating layer (step 502); positioning a first food product at least partially on a microwave interactive material on the bottom wall (step 504); positioning the floating heating layer on the food product so that a microwave interactive material on a first surface of the floating heating layer is at least partially in contact with the food product (step 506); heating the food product in a microwave oven (step 508); allowing fluids to be exchanged between the first food product and the second food product through vents in the floating heating layer (step 510).

In one embodiment, a method for heating a food product in a microwave oven comprises disposing at least one food product in contact with a floating microwave interactive material.

In another embodiment, a method for heating a food product in a microwave oven comprises positioning a food product at least partially on a microwave interactive material, positioning a floating heating layer on the food product wherein a first surface of the floating heating layer comprises a microwave interactive material at least partially in contact with the food product, and heating the food product in a microwave oven. In some embodiments, a method for heating a food product in a microwave oven further comprises positioning an article above the heating layer wherein the weight of the article maintains contact between the microwave interactive material on the heating layer and the food product during the heating of the food product.

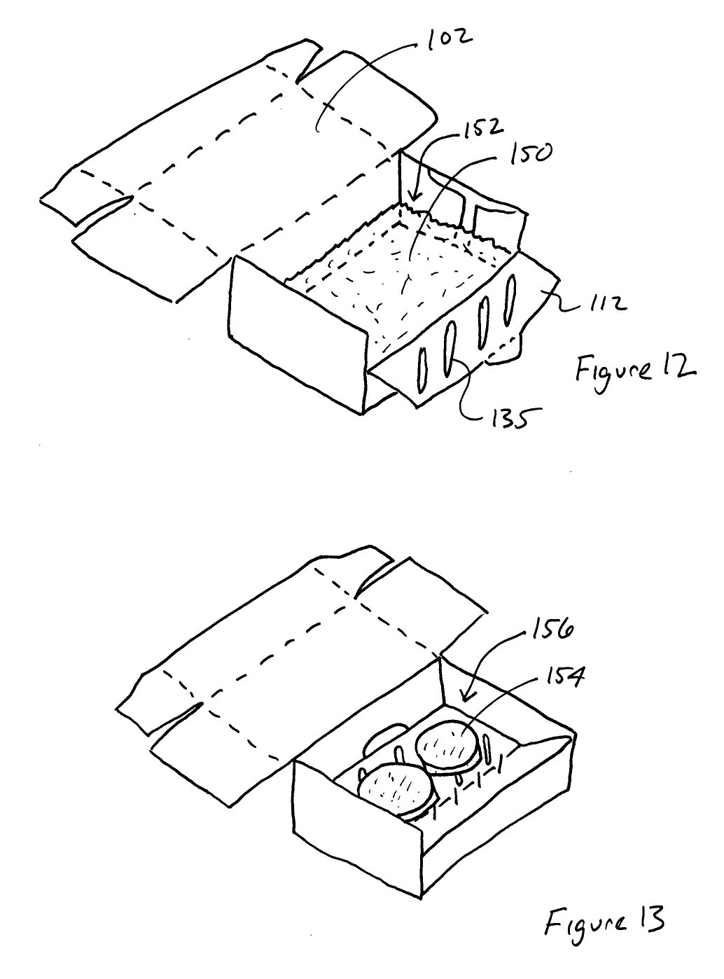

FIG. 12 is a perspective view of partially folded microwave packaging with a first food product 150 (e.g., hash browns) inserted into a first or bottom region 152.

FIG. 13 is a perspective view of the partially folded microwave packaging of FIG. 12 with the first food product 150 covered by the floating divider 112 and a second food product 154 (e.g., sausage patties) inserted onto a second or top region 156.

Desirable characteristics, which can be exhibited by exemplary embodiments, can include, but are not limited to, the provision of microwavable food packages that are consumer friendly; the provision of microwavable food packages that require minimal steps for heating; the provision of microwavable food packages that can be formed from a single blank; the provision of microwavable food packages that can be used to transport, store, and cook breakfast, lunch, and dinner food products or snacks; the provision of microwavable food packages that enhances the crispiness of food products on multiple surfaces of the food products; the provision of microwavable food packages that enhances browning of multiple surfaces of food products when heated in a microwavable oven; the provision of microwavable food packages that allow two different food products to be heated in the same package; the provision of microwavable food products that allow for the cooking of a food product that is to have a desired crispness on its outer surface as well as another food product in the same package; the provision of microwavable food packages that include a floating heating layer operable to maintain contact with a food product in the package as the food product shrinks during microwave cooking; the provision of new methods of producing microwavable food packages; the provision of methods of producing microwavable food packages that enhance the browning or crispness of food products to be cooked therein; the provision of new methods of heating food products in a microwave oven; the provision of methods of heating food products in a microwave oven that enhance the browning or crispness of food products to be cooked; and others.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

For the purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. Such joining may also relate to mechanical, fluid, or electrical relationship between the two components. Unless otherwise indicated, all numbers used in the specification are to be understood as being modified in all instances by the term “about.” Accordingly, unless indicated to the contrary, any numerical parameters set forth in the following specification are approximations that can be varied depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

It is also important to note that the construction and arrangement of the elements of the microwavable food product packaging as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. For example, any of a variety of food products may be used. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as expressed in the appended claims.

What is claimed is:

1. A microwave food package comprising:
a bottom wall comprising at least one edge;
at least one side wall comprising a top edge and a bottom edge, the bottom edge is proximate the at least one edge of the bottom wall; and
a floating divider comprising a microwave interactive material positioned above the bottom wall and within the at least one side wall to at least partially define a bottom region and a top region;
wherein the floating divider is movable relative to the bottom wall and/or side wall.

2. The microwave food package of claim 1 wherein the floating divider is not connected to the bottom wall or the side wall.

3. The microwave food package of claim 1 wherein the floating divider is connected to at least one of the bottom wall or the side wall.

4. The microwave food package of claim 1 further comprising a first food product positioned in the bottom region wherein the microwave interactive material of the floating divider rests on at least one surface of the first food product.

5. The microwave food package of claim 4 wherein the floating divider maintains at least partial contact with the food product during shipping, storage, and/or cooking of the food product in a microwave oven.

6. The microwave food package of claim 5 further comprising a second food product positioned in the top region.

7. The microwave food package of claim 6, wherein the second food article is positioned on the floating divider so that its weight further enhances contact of the floating divider with the first food product positioned in the bottom region during shipping, storage, and/or cooking of the first food product in a microwave oven.

8. The microwave food package of claim 6 wherein the divider comprises one or more vents so that oils, fats, and/or other juices evolved from the second food product can flow through the divider and onto the first food product, and wherein steam, water vapor, and/or other gases evolved from the cooking of the first food product can pass through the vents to provide moisture to the second food product.

9. The microwave food package of claim 1 wherein the microwave interactive material comprises a patterned susceptor coupled to the floating divider.

10. A microwave food package comprising:
a container including a bottom wall and at least one side wall coupled to the bottom wall; and
a divider comprising a microwave interactive material positioned above the bottom wall and within the at least one side wall;
wherein the divider at least partially defines a first region and a second region, the first region containing a first food product and the second region containing a second food product;
wherein the divider comprises one or more vents to allow passage of fluids between the first region and the second region.

11. The microwave food package of claim 10 wherein oils, fats, and/or other juices from the second food product can flow from the second region through the divider into the first region and onto the first food product.

12. The microwave food package of claim 10 wherein steam, water vapor, and/or other gases from the cooking of the first food product can pass from the first region through the vents into the second region to provide moisture to the second food product.

13. The microwave food package of claim 10 wherein the first region is located below the second region.

14. The microwave food package of claim 10 wherein the divider is unrestrained relative to the receptacle to maintain at least partial contact with the food product during shipping, storage, and/or cooking of the food product in a microwave oven

15. Microwave packaging for a food product, the packaging comprising:
a receptacle comprising a bottom wall and at least one side wall;
a first floating divider comprising a first microwave interactive material and positioned within the receptacle to at least partially defining a first region containing a first food product and a second region adjacent the first region and containing a second food product;
a second floating divider spaced apart from the first floating divider and at least partially defining a third region, the third region is adjacent the second region and contains a third food product;
wherein the first floating divider is movable so that the first microwave interactive material maintains at least partial contact with the first food product during shipping, storage, and/or cooking of the food product in a microwave oven.

16. The packaging of claim 15 wherein the bottom wall comprises a second microwave interactive material, the first microwave interactive material on a first surface of the divider and the second microwave interactive material on a second surface of the divider.

17. The packaging of claim 16 wherein the at least one side wall comprises a third microwave interactive material.

18. The packaging of claim 17 wherein weight of the second food product biases the first floating divider toward the first food product to enhance contact of the first floating divider with the first food product positioned in the first region during shipping, storage, and/or cooking of the food product in a microwave oven.

19. The packaging of claim 18 wherein the second food product rests on a second floating divider to enhance contact of the second floating divider with the article positioned in the second region of the package during shipping, storage, and/or cooking of the food product in a microwave oven.

20. The packaging of claim 19 wherein the second floating divider is movable so that the second floating divider maintains at least partial contact with the first food product during shipping, storage, and/or cooking of the food product in a microwave oven.

21. The packaging of claim 15 wherein the first divider comprises one or more vents so that oils, fats, and/or other juices evolved from the second food product can flow through the divider and onto the first food product, and wherein steam, water vapor, and/or other gases evolved from the cooking of the first food product can pass through the vents to provide moisture to the second food product.

22. A method comprising:
providing a bottom wall, at least on side wall, and a top wall, the bottom wall having a microwavable interactive material;
positioning a first food product on the microwavable interactive material on the bottom wall;
positioning a first floating divider on the first food product and above the bottom wall and within the at least one side wall, the first floating divider having a microwave interactive material on at least one major surface of the first floating divider;
positioning a second food product on the floating divider.

23. The method of claim 22 further comprising providing one or more vents to the first floating divider to allow oils, fats, and/or other juices evolved from the second food product can flow through the divider and onto the first food product, and wherein steam, water vapor, and/or other gases evolved from the cooking of the first food product can pass through the vents to provide moisture to the second food product.

24. The method of claim 23 further comprising positioning a second floating divider on the second food product and above the first floating divider and within the at least one side wall to define a third region, and positioning a third food product between the second floating divider and the top wall.

25. The method of claim 22 further comprising heating the first food product and the second food product in a microwave oven.
